(19) United States
(12) Patent Application Publication
(10) Pub. No.: US 2011/0259978 A1
(43) Pub. Date: Oct. 27, 2011

(54) AIRBRUSH

(75) Inventors: Victor Ptak, Plymouth, MI (US); Christopher Leo Ptak, Plymouth, MI (US)

(73) Assignee: M.Z. BERGER & CO., INC, Long Island City, NY (US)

(21) Appl. No.: 13/133,706

(22) PCT Filed: Jan. 6, 2009
(86) PCT No.: PCT/US09/30189

§ 371 Date: Jun. 9, 2011

(51) Int. Cl. B05B 7/04

(52) U.S. Cl. 239/398

(57) ABSTRACT

An airbrush has a housing with at least two air chambers. Each chamber is sized to receive a nib of a pen. A motor is oriented in the housing. An air pump is oriented in the housing and is driven by the motor. The air pump is in fluid communication with the at least two air chambers for forcing air into each of the at least two air chambers, about each pen nib to entrain particles from the nib into the air, and out of the housing for providing a combined spray with particles from pens of the at least two air chambers.

### BACKGROUND OF THE INVENTION

1. Technical Field

Multiple embodiments relate to an airbrush for dispensing liquid particles.

2. Background Art

The prior art offers a low end, competitively priced airbrushes. The target audience, of which this product is marketed, is typically children. These low end products typically include a plurality of markers or pens as liquid sources, rather than use of a liquid reservoir, aerosol paint supply or the like. Further, the airbrush is typically comprised of low cost plastic components providing little or no adjustability in the spray pattern or flow of the air stream.

Various techniques and designs have provided airbrushes for dispensing liquid particles onto a surface or workpiece. Although the prior art has improved cost and maneuverability of airbrushes, the quality and adjustability of spray may be compromised.

One example of an airbrush is described in U.S. Pat. No. 6,892,960, which issued on May 17, 2005 to Ptak et al. and is incorporated by reference herein.

### SUMMARY OF THE INVENTION

In one embodiment, an airbrush is disclosed having a housing with at least two air chambers. Each chamber is sized to receive a nib of a pen. A motor is oriented in the housing. An air pump is oriented in the housing and is driven by the motor. The air pump is in fluid communication with the at least two air chambers for forcing air into each of the at least two air chambers, about each pen nib to entrain particles from the nib into the air, and out of the housing for providing a combined spray with particles from pens of the at least two air chambers.

In another embodiment, an airbrush is provided with a housing having at least two air chambers that are each sized to receive a nib of a pen. A motor is oriented in the housing. An air pump is oriented in the housing and driven by the motor. A valve is in fluid communication with the air pump and the at least two air chambers. The valve receives forced air from the fluid pump and conveys the forced air to one or both of the at least two air chambers so that the air flows about one or both pen nibs to entrain particles from the one or both nibs into the air, and out of the housing for providing a spray with particles from one or both of the pens.

In yet another embodiment, an airbrush is provided with a duel reservoir housing having a pair of reservoirs each having an outlet orifice oriented so that the spray from both orifices is combined external of the housing. A pair of pens is each installed into the duel reservoir housing such that a nib of the each pen is oriented within one of the pair of reservoirs. A motor is oriented in the duel reservoir housing. An air pump is oriented in the duel reservoir housing and driven by the motor. The air pump is in fluid communication with the pair of reservoirs for forcing air into each of the pair of reservoirs, about each pen nib to entrain particles from the nib into the air, and out each outlet orifice for providing a combined spray with particles from the pair of pens of each of the pair of reservoirs.

### BRIEF DESCRIPTION OF THE DRAWINGS

FIG. 1 is a perspective view of an embodiment of an airbrush;

FIG. 2 is a front elevation view of the airbrush of FIG. 1;

FIG. 3 is a fragmentary perspective view of the airbrush of FIG. 1;

FIG. 4a is a side elevation view of a portion of the airbrush of FIG. 1;

FIG. 4b is a side elevation view of another portion of the airbrush of FIG. 1;

FIG. 5 is a cross-sectional view of a portion of the airbrush of FIG. 1;

FIG. 6a is a cross-sectional view of a portion of the airbrush of FIG. 1 illustrated in a first position;

FIG. 6b is a top plan view of the portion of the airbrush of FIG. 6a;

FIG. 7a is a cross-sectional view of a portion of the airbrush of FIG. 1 illustrated in a second position;

FIG. 7b is a top plan view of the portion of the airbrush of FIG. 5a;

FIG. 8a is a cross-sectional view of a portion of the airbrush of FIG. 1 in a third position; and

FIG. 8b is a top plan view of the portion of the airbrush of FIG. 6a.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

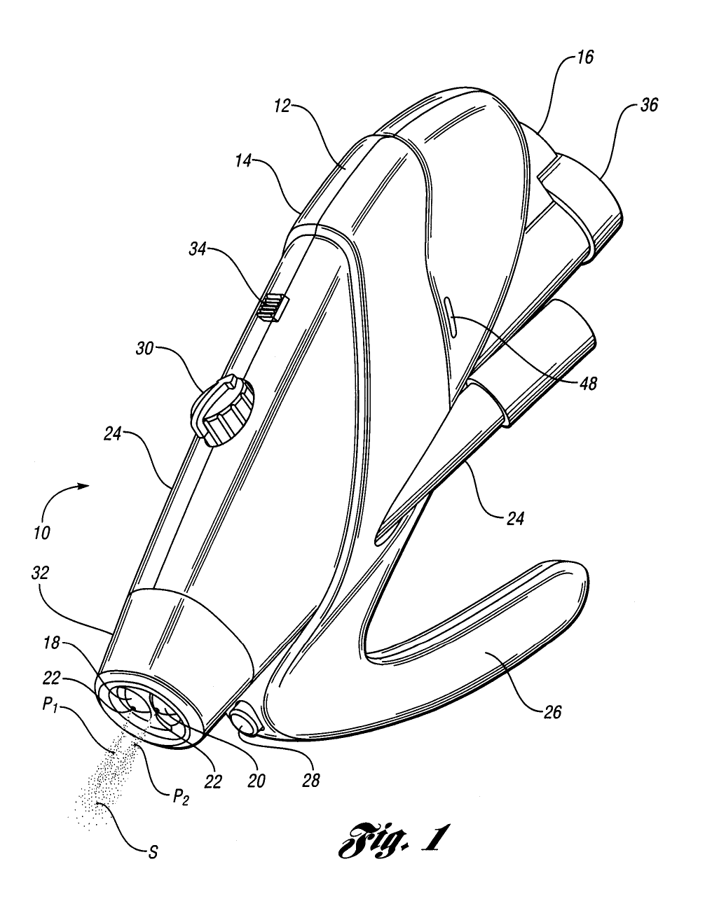

With reference to FIGS. 1 and 2, an airbrush is illustrated and is generally referenced by the numeral 10. The airbrush 10 produces an ink spray S so that a user can paint on a desired surface, as discussed further below. The airbrush 10 has an elongate shape formed by a housing 12. The housing 12 may be manufactured from a low cost, high strength material such as injection-molded plastic. In at least one embodiment, the housing 12 is formed out of a first housing portion 14 and a second housing portion 16 that join together to collectively form the housing 12. The first portion 14 and the second portion 16 may be formed of two separate half pieces, which are oriented in a clamshell manner with respect to another. The first portion 14 may be joined to the second portion 16 with fasteners. In another embodiment, the first portion 14 and the second housing portion 16 are friction welded together. In at least one embodiment, the first portion 14 and the second portion 16 are mirror images of one another such that any characteristics formed in the first portion 14 are formed in the second portion 16 and vice versa. Although some components discussed below are provided in one of the first and second housings 14, 16, the components may be provided within either of the first and second housings 14, 16. Of course, any suitable housing 12 is contemplated within the scope of the disclosed embodiments.

As illustrated, the housing 12 has a first chamber 18 and a second chamber 20 provided therein and each have an outlet orifice 22. The first chamber 18 and the second chamber 20 are each sized to receive a removable pen 24. The first chamber 18 and the second chamber 20 each receive an airflow to produce the ink spray S, which is discussed further below. Ink forming the ink spray S from each of the first chamber 18 and the second chamber 20 is provided by each removable pen 24. As illustrated, the ink spray S is formed out of a first ink stream P₁ from the removable pen 24 in the first chamber 18 and a second ink stream P₂ from the removable pen 24 of the second chamber 20. As discussed further below, a user may dispense both the first ink stream P₁ and the second ink stream P₂ to combine externally of the housing 12 to form the ink spray S, only the first ink stream P₁ or the only the second ink stream P₂. In another embodiment, sprays S, P₁, and P₂ are paint sprays. Of course, the sprays S, P₁, and P₂ may be any suitable type of sprays within the scope of the disclosed embodiments.

Ink from the removable pens 24 is entrained in airflow provided within the first chamber 18 and the second chamber 20 and then exit out of outlet orifices 23 formed in each of the first chamber 18 and the second chamber 20. In one embodiment, the first chamber 18 and the second chamber 20 are integrally formed within the housing 12. In another embodiment, the first chamber 18 and the second chamber 20 are formed separately from the housing 12. The first chamber 18 and the second chamber 20 may be partially visible external to the housing 12, as illustrated. In another embodiment, the first chamber 18 and the second chamber 20 are provided entirely within the housing 12.

Each of the first and second chambers 18, 20 are sized to receive at least a portion of the removable pen 24 therein. Although a pair of removable pens 24 is illustrated inserted into the housing 12, a user may remove the one or both of the removable pens 24 from the housing 12. The removable pens 24 may have different colors and characteristics that allow the user to vary the color and/or characteristics of the ink spray S produced by the airbrush 10. The removable pens 24 may be easily removed by the user from the either or both of the first chamber 18 and the second chamber 20 and interchange the removable pen 24 with any of a plurality of removable pens 24. The user can easily interchange color and/or pen types of the removable pens 24.

In the depicted embodiment, the airbrush 10 has a handle 26 so that the user can grasp the airbrush 10 and direct the ink spray S in a desired direction. In at least one embodiment, the handle 26 is ergonomically shaped to increase comfort and functionality during use for the user. As illustrated, the handle 26 is integrally formed with the housing 12. The handle 26 may extend from the housing 12 and may be orientated in a same general direction as the housing 12. Of course, any suitable handle 26 is contemplated within the scope of the disclosed embodiments.

As illustrated, the airbrush 10 has a trigger 28 that extends externally to the housing 12. A user can actuate the trigger 28 by pressing on the trigger in order to produce ink spray S, P₁ and/or P₂ from the airbrush 10 through the channels 18, 20 and the outlet orifices 22. The trigger 28 may be provided proximate the handle 26 so that the airbrush 10 can be held and actuated in one hand of the user. In the depicted embodiment, the trigger 28 is a push button trigger. In another embodiment, the trigger 28 is a pull trigger. Of course, any suitable trigger 28 is contemplated within the scope of the disclosed embodiments.

In at least one embodiment, a knob 30 is mounted on the housing 12 to control airflow into the first and second chambers 18, 20 in order to produce the ink spray S, P₁ and/or P₂ out of the outlet orifices 22, which is discussed further below. In at least one embodiment, the knob 30 can be rotated in at least one direction of the directions indicated by arrows A₁ and A₂.

A front cap 32 may be mounted on the housing 12 proximate the outlet orifices 22 to protect the front portion of the housing 12. The front cap 32 assists in uniting the first housing portion 14 and the second housing portion 16 and helps to maintain unity of the first housing portion 14 and the second housing portion 16. In at least one embodiment, the front cap 32 is removable without use of tools so that the front cap 32 can be cleaned so that the airbrush 10 remains clean even after use.

As depicted in FIG. 1, a switch 34 is provided external to the housing 12. As discussed further below, the switch 34 controls operation of a motor. When the switch 34 is in a first position, the airbrush 10 is turned off and does not produce the ink stream S, P₁ and/or P₂. When the switch 34 is in a second position, the airbrush 10 is operable by actuating the trigger 28 to produce the ink stream S, P₁ and/or P₂ as desired.

A removable cap 36 is mounted on the housing 12 to allow the user insert batteries into and remove batteries from the housing 12. Batteries are utilized to power the airbrush, as discussed further below. The removable cap 36 may be retained on the housing by a fastener or in any suitable manner.

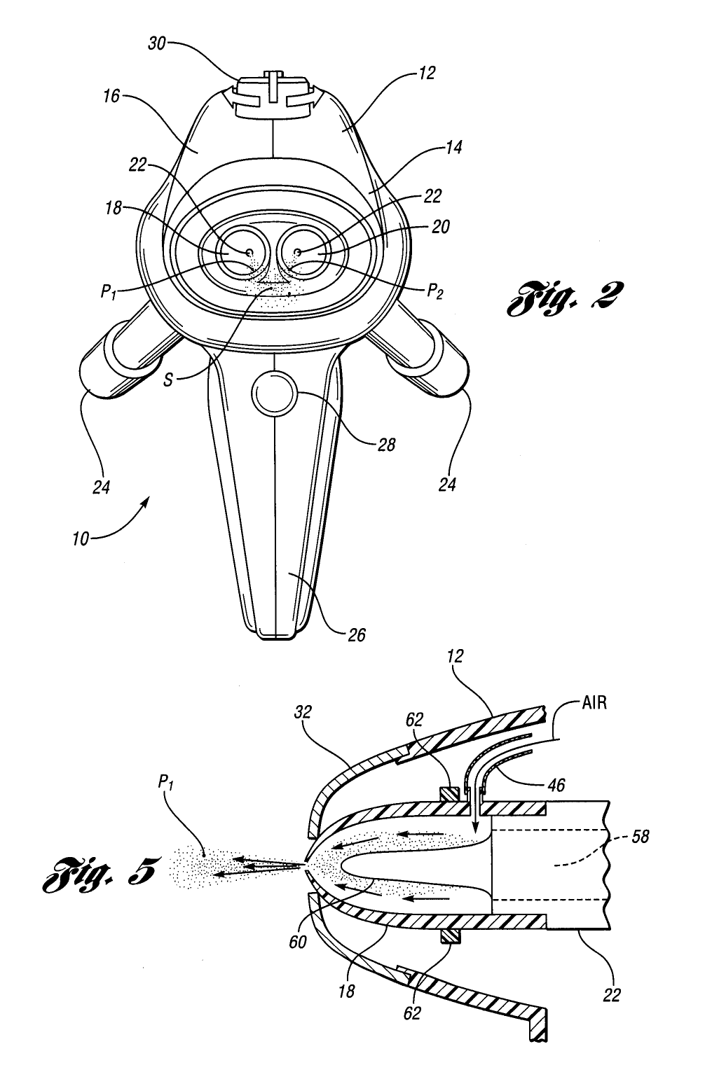

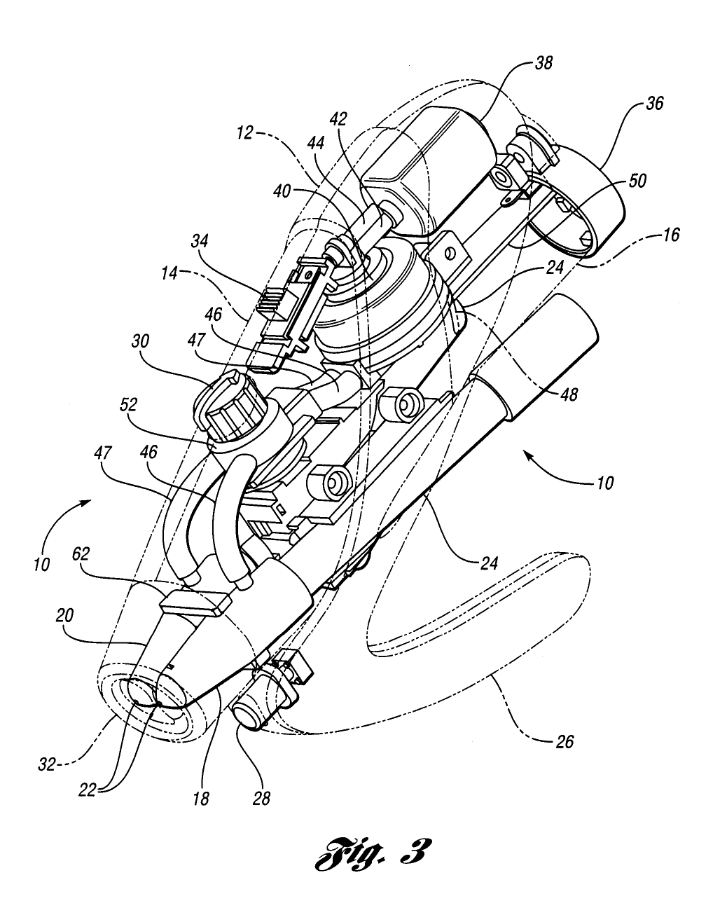

Referring now to FIGS. 3 and 4a-4b, the airbrush 10 of FIG. 1 is illustrated showing inner components. In FIG. 3, the housing 12 is shown in phantom. In FIG. 4a, the first housing portion 14 is illustrated with a portion of the inner components provided therein and in FIG. 4b, the second housing portion 16 is illustrated with a portion of the inner components provided therein so that collectively FIGS. 4a and 4b form the airbrush 10 of FIG. 1.

As illustrated in FIGS. 3 and 4a, a motor 38 is provided within the housing 12. The motor 38 may be a DC electric motor. An air pump 40 is also provided within the housing 12 and is operatively driven by the motor 38. The motor 38 is illustrated having an output shaft 42 rotationally driven by the motor 38 and provided with an eccentric drive 44 cooperating with the air pump 40. Of course, any suitable motor 38 is contemplated within the scope of the disclosed embodiments.

The air pump 40 is illustrated as a bellows pump having one end fixed, and a diaphragm which is movable in a reciprocating direction as illustrated by the double arrow provided proximate the air pump 40. The eccentric drive 44 drives the bellows pump 40 in a manner such that the diaphragm reciprocates for forcing the air from the bellows pump 40 through a pair of tubes 46, 47 within the housing 12. The pair of tubes 46, 47 provide a fluid connection between the air pump 40 and the first and second chambers 18, 20. In at least one embodiment, the pair of tubes 46, 47 are flexible so that the tubes 46, 47 can move while assembling the airbrush 10 and after assembly is complete.

To supply the air pump 40 with a supply of air, both the housing 12 may include an air intake port 48, as illustrated in FIG. 1, for permitting air to enter the housing 12, and consequently the air pump 40. The intake port 48 may be provided on the first housing 14 and/or the second housing 16 and may be provided proximate the air pump 40. Although a bellows pump 40 is illustrated, any suitable air pump 40 is contemplated within the scope of the disclosed embodiments.

The combination of the motor 38 and the air pump 40 provide a source of compressed air that is low cost in light of the components or equipment required, yet is sufficient to provide a continuous flow of air resulting in a steady air stream for dispensing liquid particles. Furthermore, the motor 38 and air pump 40 are relatively small in size and light in weight to efficiently and ergonomically orient within the airbrush 10 without adversely affecting the maneuverability of the airbrush 10 when in use.

A battery compartment 50 is oriented within the housing 12 for receiving batteries to provide a source of power to the motor 38. The motor 38 is electrically connected to the batteries within the battery compartment 50 and to the switch 34. The switch 34 is illustrated as a slide switch oriented within the housing 12, and extending externally therefrom. The switch 34 closes the electrical connection between the batteries in the battery compartment 50 and motor 38 when moved by the user from an off position to an on position, as known in the art. When the switch 34 is in the on position, the airbrush 10 can be actuated by the user pressing the trigger 28 to dispense the ink spray.

The user actuates the trigger 28 to complete the electrical connection between the motor 38, the air pump 40, the switch 34 and the batteries of the battery compartment 50. When the switch 34 is in on position, the user can selectively actuate the trigger 28 to close the electrical connection and dispense the ink spray as desired. The user can turn the knob 30, which is connected to a valve 52 in order to produce various sprays out of the first chamber 18 and/or the second chamber 20. As discussed further below, the valve controls air flow through the tubes 46, 47 which can cause ink spray to be produced from the removable pens 22 of each the first and second air chambers 18, 20, from of only the first chamber 18 or from of only the second chamber 20.

Referring now to FIG. 4b, the removable pen 22 can be inserted through an aperture 54 formed in the housing 12. The housing 12 may have a pen support member 56 provided therein to support the removable pen 22 and guide the removable pen 22 into the air chambers 18, 20. As illustrated, the pen support member 56 may be separately formed from the housing 12 and mounted within the housing 12. In another embodiment, the pen support member 56 may be integrally formed within the housing 12. Although the aperture 54 and the pen support member 56 are shown in the second housing 16, the first housing also has a corresponding aperture 54 and pen support member 56 to support the removable pen 22 that is inserted into the first chamber 18. Of course, any suitable aperture 54 and pen support member 56 are contemplated within the scope of the disclosed embodiments.

As depicted in FIG. 5, the removable pen 22 has a liquid reservoir 58 and nib 60. When the switch 34 is in the one position and the user selectively actuates the trigger 28 causing the motor 38 to drive the air pump 40, as discussed above, an air stream of pressurized air through the tube 46 and into the air chamber 18. The air stream, illustrated as arrows located within the air chamber 18, flows about the nib 60 of the removable pen 22. The air stream consequently draws liquid particles from the nib 60 by the Bernoulli effect of the flow of air over the nib 60. As the air stream passes the nib 60, it forms a mist that is sprayed from an outlet orifice 22. The mist exiting the airbrush 10 provides the ink stream P₁. Although one air chamber 18 is illustrated, the air chamber could be either the first air chamber 18 or the second air chamber 20 to provide the first ink stream P₁ or the second ink stream P₂.

As illustrated, the air chamber 18 is supported within the housing 12 by a chamber support member 62. As illustrated, the chamber support member 62 may be separately formed from the housing 12 and mounted within the housing 12. In another embodiment, the chamber support member 62 may be integrally formed within the housing 12. Any suitable chamber support member 62 is contemplated within the scope of the disclosed embodiments.

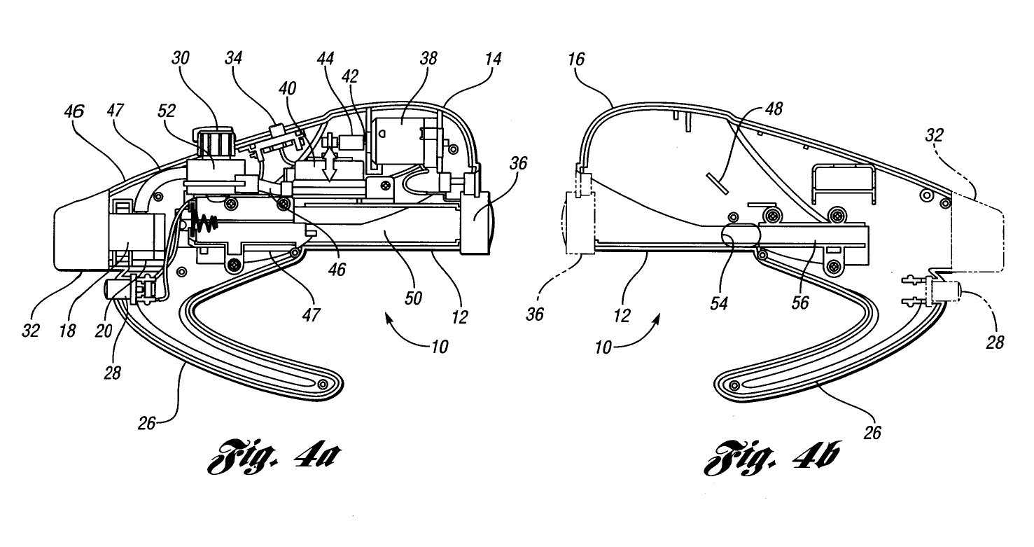

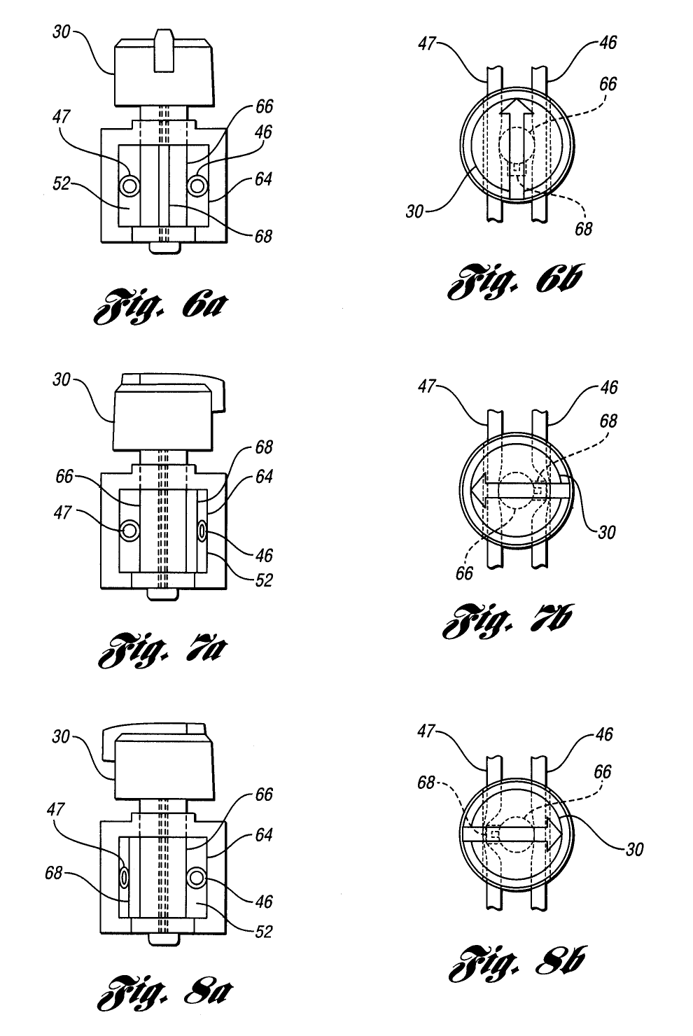

With reference now to FIGS. 6a-8b, the knob 30, first and second tubes 46, 47 and the valve 52 are illustrated in further detail. In FIGS. 6a and 6b, the valve 52 is in a first position permitting the air to flow from the air pump 40 to the first and second air chambers 18, 20 such that the spray includes particles from the pens in the first and second air chambers 18, 20. In FIGS. 7a and 7b, the valve 52 is in a second position permitting the air to flow from the air pump 40 into only the first air chamber 18. In FIGS. 8a and 8b, the valve 52 is in a third position permitting the air to flow from the air pump 40 into only the second air chamber 20.

The valve 52 has a shaft 66 and a radially offset projection 68, which interact with the first tube 46 and the second tube 47 to restrict air flow. The radially offset projection 68 does not directly interact with the air flowing through either the first tube 46 or the second tube 47 in order to prevent ink, from the removable pens 22 described above, from drying and locking the valve 52. In addition, the configuration of the valve 52 with the shaft 66 and the radially offset projection 68 allows for a cleaning operation of the first tube 46 and the second tube 47 when the airbrush 10 is operated without removable pens 22.

Referring now to FIGS. 6a-6b, the valve 52 is in the first position so that the first tube 46 and the second tube 47 provide the fluid communication between the air pump and the respective first air chamber 18 and the second air chamber 20. In the illustrated embodiment, a valve compartment 64 is provided and the valve 52 is mounted within the valve compartment 64. The first tube 46 and the second tube 47 run through the valve compartment 64.

In the depicted embodiment, the shaft 66 and the radially offset projection 68 do not restrict the flow of the air in the first tube 46 and the second tube 47 when the valve is in the first position. The projection 68 may be mounted to the shaft 66, as illustrated. In another embodiment, the shaft 66 and the projection 68 are integrally formed. The shaft 66 is connected to the knob 30 so that when the knob 30 is manually turned by the user, the shaft 66 and projection 68 rotate to obstruct the flow of the air of one of the first tube 46 and the second tube 47. When the user operates the airbrush 10 with the valve 52 in the first position, air flows through both the first tube 46 and the second tube 47 to produce the ink spray S from the combined ink sprays P₁ and P₂ out of both the first chamber 18 and the second chamber 20, as illustrated in FIG. 1.

In FIGS. 7a-7b, the knob 30 has been rotated approximately ninety degrees from the first position to the second position so that the knob 30, the shaft 66 and the projection 68 have also rotated to the second position. As illustrated, the offset projection 68 obstructs the flow of the air of the first tube 46 displacing the tube 46 to close the tube 46 against the valve compartment 64. When the valve 52 is in the second position illustrated, air flows though only the second tube 47 to the second chamber 20 so that only the second ink stream P₂ is produced.

In FIGS. 8a-8b, the knob 30 has been rotated approximately ninety degrees from the first position to the third position and one hundred-eighty degrees from the second position to the third position, so that the knob 30, the shaft 66 and the projection 68 have also rotated to the third position. As illustrated, the offset projection 68 obstructs the flow of the air of the second tube 47 displacing the tube 47 to close the tube 47 against the valve compartment 64. When the valve 52 is in the third position illustrated, air flows though only the first tube 46 to the first chamber 18 so that only the second ink stream P₁ is produced.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An airbrush comprising:
a housing having at least two air chambers, each sized to receive a nib of a pen;
a motor oriented in the housing; and
an air pump oriented in the housing and driven by the motor, the air pump being in fluid communication with the at least two air chambers for forcing air into each of the at least two air chambers, about each pen nib to entrain particles from the nib into the air, and out of the housing for providing a combined spray with particles from pens of the at least two air chambers.

2. The airbrush of claim 1 further comprising at least two pens, each installed into one of the at least two air chambers.

3. The airbrush of claim 1 wherein at least two outlet orifices are formed in the housing, each in fluid communication with one of the at least two air chambers to outlet the spray from the housing.

4. The airbrush of claim 3 wherein the at least two outlet orifices are oriented so that the spray from each of the at least two outlet orifices combines external of the housing.

5. The airbrush of claim 1 further comprising a valve in fluid communication with the air pump and the at least two air chambers for controlling a flow of air from the air pump to the at least two air chambers to consequently control a concentration of the particles from each of the pens in the output spray.

6. The airbrush of claim 5 wherein the valve cooperates with the air pump and the at least two air chambers to interrupt the flow of air from the air pump to either of the at least two air chambers.

7. The airbrush of claim 5 wherein the valve cooperates with the air pump and the at least two air chambers to permit the flow of air from the air pump to both of the at least two air chambers concurrently.

8. The airbrush of claim 1 further comprising at least a pair of flexible tubes, each tube being in fluid communication with the air pump and one of the at least a pair of air chambers.

9. The airbrush of claim 8 further comprising a valve in cooperation with the at least a pair of flexible tubes for controlling a flow of air from the air pump to the at least two air chambers to consequently control a concentration of the particles from each of the pens in the output spray.

10. The airbrush of claim 9 further comprising a valve compartment oriented within the housing;
wherein the at least a pair of tubes extend through the valve compartment;
wherein the valve has a first position permitting the air to flow from the air pump to the first and second air chambers such that the spray includes particles from the pens in the first and second air chambers;
wherein the valve has a second position that presses a first of the at least a pair of tubes against the valve compartment, thereby preventing the air from flowing from the air pump to a first of the at least a pair of air chambers and permitting the air to flow from the air pump to a second of the at least a pair of air chambers such that the spray includes particles from the pen in the second air chamber only; and
wherein the valve has a third position that presses a second of the at least a pair of tubes against the valve compartment, thereby preventing the air from flowing from the air pump to the second air chamber and permitting the air to flow from the air pump to the first air chamber such that the spray includes particles from the pen in the first air chamber only.

11. The airbrush of claim 10 wherein the valve further comprises:
a shaft pivotally connected to the valve compartment between the at least a pair of tubes; and
a radially offset projection mounted to shaft and oriented between the at least a pair of tubes for pressing one of the at least a pair of tubes against the valve compartment.

12. The airbrush of claim 11 further comprising a manual knob mounted to the valve shaft external of the housing for manual selection of the valve position.

13. The airbrush of claim 1 further comprising:
a handle extending from the housing; and
a switch for controlling operation of the motor.

14. An airbrush comprising:
a housing having at least two air chambers, each sized to receive a nib of a pen;
a motor oriented in the housing;
an air pump oriented in the housing and driven by the motor; and
a valve in fluid communication with the air pump and the at least two air chambers for receiving forced air from the fluid pump and conveying the forced air to one or both of the at least two air chambers so that the air flows about one or both pen nibs to entrain particles from the one or both nibs into the air, and out of the housing for providing a spray with particles from one or both of the pens.

15. The airbrush of claim 14 wherein the valve cooperates with the air pump and the at least two air chambers to interrupt the flow of air from the air pump to either of the at least two air chambers.

16. The airbrush of claim 14 wherein the valve cooperates with the air pump and the at least two air chambers to permit the flow of air from the air pump to both of the at least two air chambers concurrently.

17. The airbrush of claim 14 further comprising at least a pair of flexible tubes, each tube being in fluid communication with the air pump and one of the at least a pair of air chambers, wherein the valve is in cooperation with the at least a pair of flexible tubes for controlling a flow of air from the air pump to the at least two air chambers to consequently control a concentration of the particles from each of the pens in the output spray.

18. The airbrush of claim 17 further comprising a valve compartment oriented within the housing;
wherein the at least a pair of tubes extend through the valve compartment;
wherein the valve has a first position permitting the air to flow from the air pump to the first and second air chambers such that the spray includes from the pens in the first and second air chambers;
wherein the valve has a second position that presses a first of the at least a pair of tubes against the valve compartment, thereby preventing the air from flowing from the air pump to a first of the at least a pair of air chambers and permitting the air to flow from the air pump to a second of the at least a pair of air chambers such that the spray includes particles from the pen in the second air chamber only; and
wherein the valve has a third position that presses a second of the at least a pair of tubes against the valve compartment, thereby preventing the air from flowing from the air pump to the second air chamber and permitting the air to flow from the air pump to the first air chamber such that the spray includes particles from the pen in the first air chamber only.

19. The airbrush of claim 18 wherein the valve further comprises:
a shaft pivotally connected to the valve compartment between the at least a pair of tubes;
a radially offset projection mounted to shaft and oriented between the at least a pair of tubes for pressing one of the at least a pair of tubes against the valve compartment; and
a manual knob mounted to the valve shaft external of the housing for manual selection of the valve position.

20. An airbrush comprising:
a duel reservoir housing having a pair of reservoirs each having an outlet orifice oriented so that the spray from both orifices is combined external of the housing;
a pair of pens each installed into the duel reservoir housing such that a nib of the each pen is oriented within one of the pair of reservoirs;
a motor oriented in the duel reservoir housing; and
an air pump oriented in the duel reservoir housing and driven by the motor, the air pump being in fluid communication with the pair of reservoirs for forcing air into each of the pair of reservoirs, about each pen nib to entrain particles from the nib into the air, and out each outlet orifice for providing a combined spray with particles from the pair of pens of each of the pair of reservoirs.
